(19) United States
(12) Patent Application Publication
(10) Pub. No.: US 2026/0343087 A1
(43) Pub. Date: Oct. 29, 2026

(54) Real-Time Feedback to Improve Image Capture

(71) Applicant: Google LLC, Mountain View, CA (US)

(72) Inventors: Lingeng Wang, Berkeley, CA (US); Paul Samuel Kim, Sunnyvale, CA (US); Dimitri de Abreu e Lima Luedemann, Nevada City, CA (US); Seungyon Lee, Sunnyvale, CA (US); Bingying Xia, Tokyo (JP); Chia-Fang Lue, Taipei (TW); Ching Wen Fu, Taipei (TW); Leung Wun King, New Taipei City (TW); Chien-Hsin Lee, Taipei (TW); Christopher Le, San Jose, CA (US); Kuan-Ying Huang, New Taipei City (TW); Shana Nicole Sager, Sunnyvale, CA (US); Seri Lee, New Taipei (TW); Chung-Ko Chiu, New Taipei City (TW); Harrison Zachary Zafrin, London (GB); Alexander Chao, Newark, CA (US)

(21) Appl. No.: 19/118,213

(22) PCT Filed: Oct. 4, 2023
(86) PCT No.: PCT/US2023/034460

§ 371 Date: Apr. 3, 2025

Related U.S. Application Data
(60) Provisional application No. 63/378,634, filed on Oct. 6, 2022.

(51) Int. Cl. H04N 23/60; G06F 3/01; G06F 3/16; H04N 23/611; H04N 23/63

(52) U.S. Cl. CPC H04N 23/64; H04N 23/611; H04N 23/635; G06F 3/016; G06F 3/167

(57) ABSTRACT

This document describes systems and techniques directed to providing real-time feedback to improve self-portrait photographs (selfies) or other images for camera users (e.g., low-vision camera users). In aspects, the systems and techniques are implemented on computing devices having a front-facing camera or a rear-facing camera. The systems and techniques may track the user's face and provide haptic, audio, and/or visual feedback to guide the user to position at least one of the computing device or the user so that the user becomes positioned in a center of frame of the camera. In an aspect, a user interface may display visual indicators that flash over a viewfinder image of a camera displayed on a computing device display. The visual indicators may increase in brightness near a user's face to guide a user to the center of the frame of the camera. In another aspect, the user interface may display a high-contrast outline of the user's face and/or torso on the display to provide feedback to the user of their position in the frame. In another aspect, the user may receive an audio detail description of what is in the viewfinder to confirm desired faces and objects are included. Through such systems and techniques, a user can take a high-quality self-portrait even when they have limited or no ability to see a display screen of the computing device.

### BACKGROUND

Front-facing cameras on computing devices allow a user of the computing device to capture self-portrait photographs, also referred to as “selfies.” When the user takes a selfie, they may look at a display of the computing device to position themselves, and any other desired objects for the photograph, respective to the field-of-view of the camera (e.g., a viewing frame). Finding a perfect angle for a selfie can be particularly challenging for blind and low-vision users (collectively “low-vision users” herein). If it is difficult for the low-vision user to see the display screen, the quality of the selfie may be poor with undesirable framing and angles.

Additionally, low-vision users who use a voice-based accessibility service (e.g., screen reader) currently receive limited audio assistance when taking a selfie, making it a guessing game for a good photo. The latency associated with the limited audio assistance makes it even less useful. Further, the user may need to look away from the display to the camera lens and then press a shutter button to take the selfie, potentially inducing a movement of the camera that degrades the quality of what the user intended to capture in the selfie.

### SUMMARY

This document describes systems and techniques directed to providing real-time feedback to improve self-portrait photographs (aka “selfies”) as well as other image capture for a camera user (e.g., a low-vision user). A selfie is captured by a device or component capable of capturing an image (e.g., camera, front-facing camera) of a computing device (e.g., mobile device, smartphone, tablet computer) and may include one or more objects (e.g., a user's face). The disclosed systems and techniques may track a user's face and provide at least one of haptic, audio, or visual feedback to guide the user to position at least one of the computing device or the user so that the user becomes positioned in a center of frame of the camera. By so doing, the systems and techniques described herein may enable the user to capture an attractive selfie without relying on the user to preview a captured selfie image on a display of the computing device. Further examples involve facilitating image capture of multiple objects, for instance, multiple faces of different people or other types of objects. Such examples may involve a rear-facing camera of a computing device as well or instead of a front-facing camera. Particular types of objects (e.g., faces, pets, documents) may be prioritized. At least one of haptic, audio, or visual feedback may be provided to guide the user to position the camera to include the objects in a viewfinder of the camera. Verbal feedback may be provided to identify the objects included in the field of view before image capture to enable accurate image capture by low-vision users.

In one aspect, a method includes receiving an input from a user to initiate a camera of the computing device to capture an image of an environment. The method further includes detecting one or more objects of interest in the environment. The method further includes providing at least one of haptic, audio, or visual feedback to guide the user to position the computing device so that the one or more objects of interest become positioned within a viewfinder of the camera. The method further includes providing vocal feedback to identify the one or more objects of interest positioned within the viewfinder of the camera. The method further includes causing the camera to capture the image.

In another aspect, a computing device is configured to receive an input from a user to initiate a camera to capture an image of an environment. The computing device is further configured to detect one or more objects of interest in the environment. The computing device is further configured to provide at least one of haptic, audio, or visual feedback to guide the user to position the computing device so that the one or more objects of interest become positioned within a viewfinder of the camera. The computing device is further configured to provide vocal feedback to identify the one or more objects of interest positioned within the viewfinder of the camera. The computing device is further configured to cause the camera to capture the image.

In another aspect, a non-transitory computer readable medium includes program instructions executable by one or more processors to perform operations comprising receiving an input from a user to initiate a camera of the computing device to capture an image of an environment. The operations further include detecting one or more objects of interest in the environment. The operations further include providing at least one of haptic, audio, or visual feedback to guide the user to position the computing device so that the one or more objects of interest become positioned within a viewfinder of the camera. The operations further include providing vocal feedback to identify the one or more objects of interest positioned within the viewfinder of the camera. The operations further include causing the camera to capture the image.

In another aspect, means are provided for performing the method described above.

This Summary is provided to introduce simplified concepts for providing real-time feedback to improve self-portrait photographs and other types of image capture for camera users, which is further described below in the Detailed Description and is illustrated in the Drawings. This Summary is intended neither to identify essential features of the claimed subject matter nor for use in determining the scope of the claimed subject matter.

### BRIEF DESCRIPTION OF THE DRAWINGS

The details of one or more aspects of providing real-time feedback to improve self-portrait photographs and other types of image capture for camera users are described in this document with reference to the following drawings, where the use of same numbers in different instances may indicate similar features or components:

FIG. 1 is a schematic illustration of an example computing device;

FIGS. 2A-2C illustrate an example user interface sequence;

FIG. 3 illustrates example combinations of auditory, haptic, and visual feedback that may be provided to a user at different moments;

FIG. 4 illustrates an example of a high-contrast outline;

FIG. 5 illustrates an example of providing an audio detail description of the content present in a viewing frame of a camera;

FIG. 6 illustrates zones of a viewfinder of a camera;

FIG. 7 illustrates feedback associated with different zones of a viewfinder of a camera;

FIG. 8 illustrates different colored rings of a user interface;

FIG. 9 illustrates a table of object prioritizations;

FIG. 10 illustrates examples of border guidance;

FIG. 11 illustrates an example computing device;

FIG. 12 is a simplified block diagram showing some of the components of an example computing system; and FIG. 13 is a block diagram of an example method.

### DETAILED DESCRIPTION

This document describes systems and techniques directed to providing real-time feedback to improve self-portrait photographs (selfies) as well as other image capture for a camera user (e.g., a low-vision camera user). In aspects, the systems and techniques are implemented on computing devices that include a device or component capable of capturing an image (e.g., camera, front-facing camera, rear-facing camera) configured to capture a selfie image or other image of an environment. The systems and techniques may track the user's face and provide at least one of haptic feedback, audio feedback, or visual feedback to guide the user to position at least one of the computing device or the user so that the user becomes positioned in a center of frame of the camera. By so doing, the techniques described herein may enable the user to capture an attractive selfie without relying on the user to preview a captured selfie image on a display of the computing device.

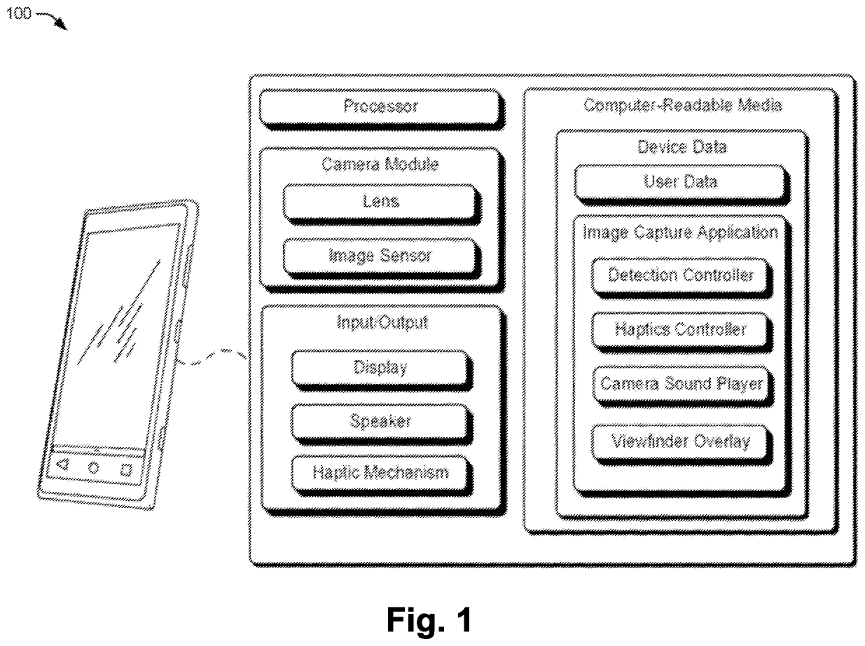

FIG. 1 illustrates an example computing device 100 in which the described systems and techniques can be implemented. As illustrated in FIG. 1, the computing device 100 is a smartphone. In some implementations, the computing device can be a variety of other electronic devices (e.g., digital cameras, tablet computers, computers, smartwatches, and so forth). The computing device 100 may include a processor, an input/output device (e.g., a display, a speaker, a haptic mechanism (e.g., DC motor that creates vibrations)), and a camera module. In aspects, the camera module is a device or component capable of capturing an image (e.g., a front-facing camera). The camera module may include a lens and an image sensor.

The computing device 100 may also include a computer-readable media (CRM) that stores device data (e.g., user data, multimedia data, applications, an operating system). The device data may include instructions of an image capture application that, responsive to execution by the processor, cause the processor to perform operations described in this document to utilize the image sensor, image processing capabilities, and feedback capabilities of the computing device to provide real-time feedback that improves selfies for a camera user. The image capture application may include a detection controller, a haptics controller, a camera sound player, and a viewfinder overlay.

The entities of FIG. 1 may be further divided, combined, used along with other sensors (e. g, accelerometers or gyros) or components, and so on. In this way, different implementations of computing devices, with different configurations, can be used to implement providing real-time feedback to improve selfies for a camera user. The example computing device 100 of FIG. 1 illustrates but some of many possible devices capable of employing the described techniques. Although described with reference to a front-facing camera, any of the described aspects may also be applied to assist users with capturing self-portraits or other types of photos using a back-facing camera, a remote camera (e.g., wirelessly linked), or the like.

The techniques include methods of providing real-time feedback to improve self-portrait photographs for camera users. The described methods may operate separately or together in whole or in part. The methods may be performed by a computing system (e.g., computing system 100) in accordance with one or more aspects of providing real-time feedback to improve selfies. The methods are described as operations performed but are not necessarily limited to the order or combinations shown for performing the operations. Further, one or more of the operations may be repeated, combined, reorganized, reordered, or linked to provide a wide array of additional and/or alternate methods. In portions of the following discussion, reference may be made to the example computing device 100 of FIG. 1 or to entities or processes as detailed in other Figures, reference to which is made for example only. The techniques are not limited to performance by one entity or multiple entities operating on one device. A method may use elements of any of the Figures.

In example methods, assume that a user initiates a front-facing camera of a smartphone (computing device) to take a selfie. The image capture application is initiated, and the detection controller may detect a face or a portion of a face (collectively a “face portion”) in the viewing area of the front-facing camera (e.g., in a center portion of the camera frame). The detection controller may calculate a distance from the face to a center portion of the camera frame and provide it to the haptics controller. The haptics controller may segment the camera's viewfinder into zones. As a user's face transitions between zones, the haptic controller may generate (cause) haptic feedback (i.e., vibrations) and audio feedback to change states. For example, the vibration of the phone and/or an audio pattern produced can become more rapid, intense, and high-pitched as the face approaches a zone at the center of the camera frame that is desirable for selfies.

Haptics may indicate a direction (e.g., up, down) to move the smartphone and/or a distance (e.g., near, far). The haptics controller may compose haptic feedback for the haptic mechanism in combination with audio feedback. Audio feedback may be communicated to the user via the camera sound player and the speaker. A viewfinder overlay initiates communication of visual information via a user interface (UI) to a user. As discussed below, the UI may overlay a display and include a visual indicator. For example, a visual indicator that flashes, a checkmark, and/or a high-contrast outline. The user may receive the haptic, audio, and/or visual feedback and continue to adjust the position or orientation of the smartphone. The image capture application and its modules may repeat the process (e.g., every 100-200 milliseconds) to track the face, calculate a distance, and communicate feedback.

Also disclosed are systems that may include an apparatus comprising a processor and a computer-readable storage media (CRM) having stored thereon instructions that, responsive to execution by the processor, cause the processor to perform a disclosed method.

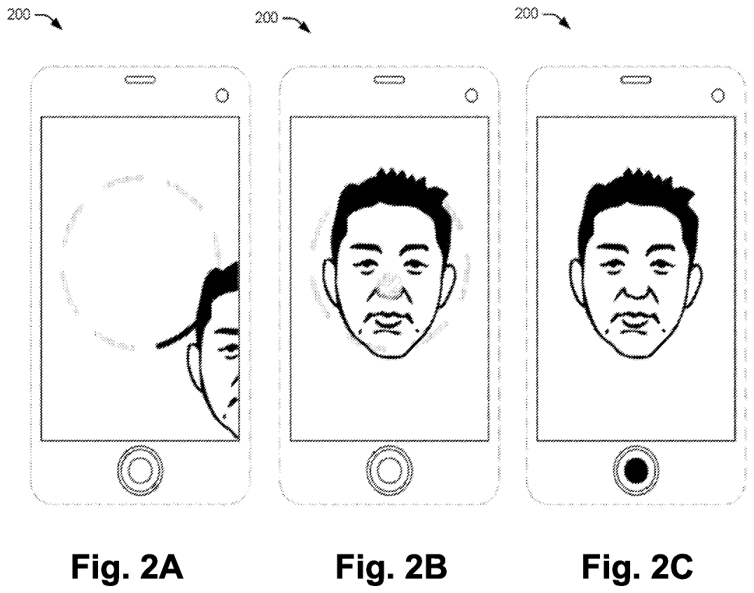

FIGS. 2A, 2B, and 2C illustrate an example UI overlaid on the viewfinder of a camera (e.g., a camera application) that is displayed on a smartphone display. As illustrated in FIG. 2A, the UI 200 controlled by the viewfinder overlay may display visual indicators that flash to help guide a user to the center of the camera frame. For example, a user interface may display visual indicators that flash over a viewfinder image of a camera displayed on a computing device display. The visual indicators may increase in brightness near a user's face to guide a user to the center of the frame of the camera. The visual indicator flash may be displayed in the UI as several translucent dashes that approximate a circle and increase in brightness or color when a user's face is nearby. FIG. 2A illustrates a visual indicator flash closest to the face (in the lower right quadrant) highlighted to provide visual cues to the user. The user can adjust the position, orientation, and/or angle of the smartphone to center themselves in the dashed circle. FIG. 2B illustrates the UI 200 displaying a confirmation to the user that they are in the center of the camera frame with a checkmark. FIG. 2C illustrates that the UI 200 (e.g., checkmark and dashed circle) may fade once the center of the camera frame is reached and the camera may take the photo without additional user input. Through such systems and techniques, a user can take a high-quality self-portrait even when they have limited or no ability to see a display screen. The UI may be displayed in addition to auditory feedback and/or haptic feedback to provide a rich user experience.

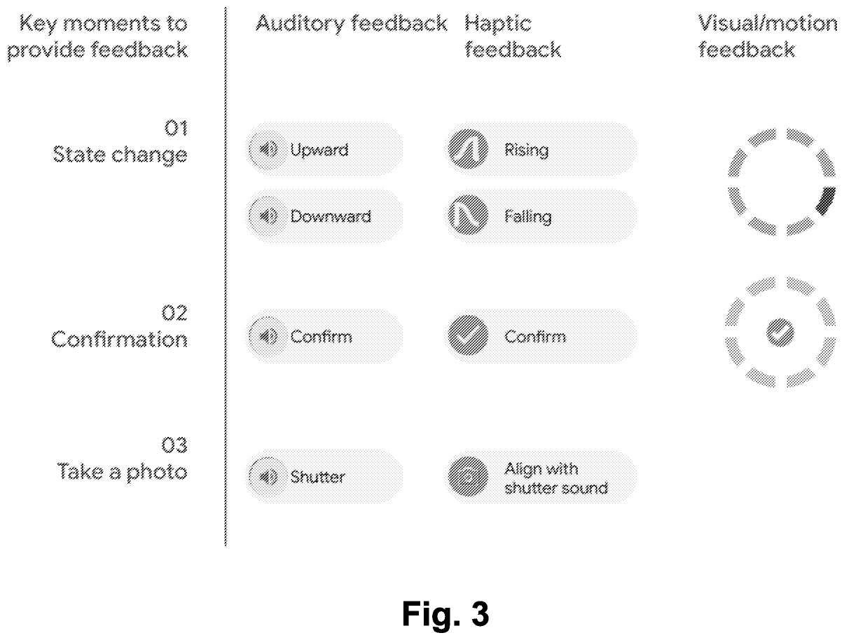

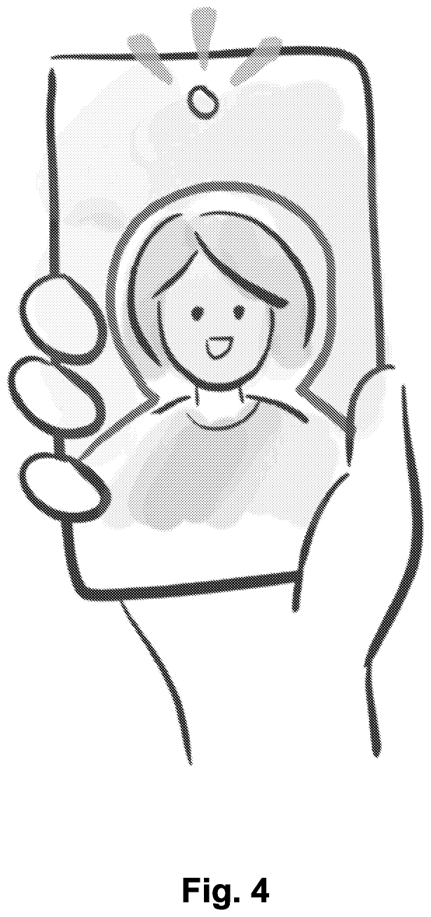

FIG. 3 illustrates example combinations of auditory, haptic, and visual feedback that may be provided to a user at different moments. For example, when the user is finding the center of the camera frame, when the center of the frame is achieved, and when a photo is taken by the camera module. As illustrated in FIG. 3, the smartphone may be performing audio feedback of an increasingly high-pitched sound and/or the haptic feedback may change (e.g., increase or decrease) as the user's face becomes more prominent in the center of the frame. For example, the haptic feedback may be a haptic pattern that increases in strength with perceived intensity increasing as the user's face approaches the center of the frame. Alternatively, the haptic pattern may be temporal with an increase in the pulse speed as the user's face approaches the center of the camera frame. When the smartphone UI displays a checkmark, the smartphone may provide confirmation sounds and confirmation haptic feedback. Finally, audio feedback and haptic feedback can confirm to a low-vision user that a photo has been taken.

FIG. 4 illustrates an example of a UI 400 displaying a high-contrast outline of the user's face and/or torso on the display to provide feedback to the user relating to their position in the frame and to guide the user to the center of the frame. As illustrated in FIG. 4, the image capture application may provide a high-contrast outline in a UI displayed over the viewfinder of the camera. For example, assume that a user initiates a front-facing camera of a smartphone to take a selfie. The image capture application is initiated, and the detection controller may detect a face. A UI controlled by the image capture application on the smartphone may display a bright, high-contrast outline around a face and/or torso (displayed as a red line). The outline may allow a low-vision user to locate themselves in the center of the camera frame more easily. The outline may update as the image capture application repeats the tracking process (e.g., every 100-200 milliseconds) and may be provided in addition to the audio, haptic, and/or visual feedback discussed above and illustrated in FIG. 3. The image capture application may automatically take more than one photo (e.g., from different angles) when a user tilts a smartphone and automatically select the best photo for the user. Through such systems and techniques, a user can take a high-quality self-portrait even when they have limited or no ability to see a display screen.

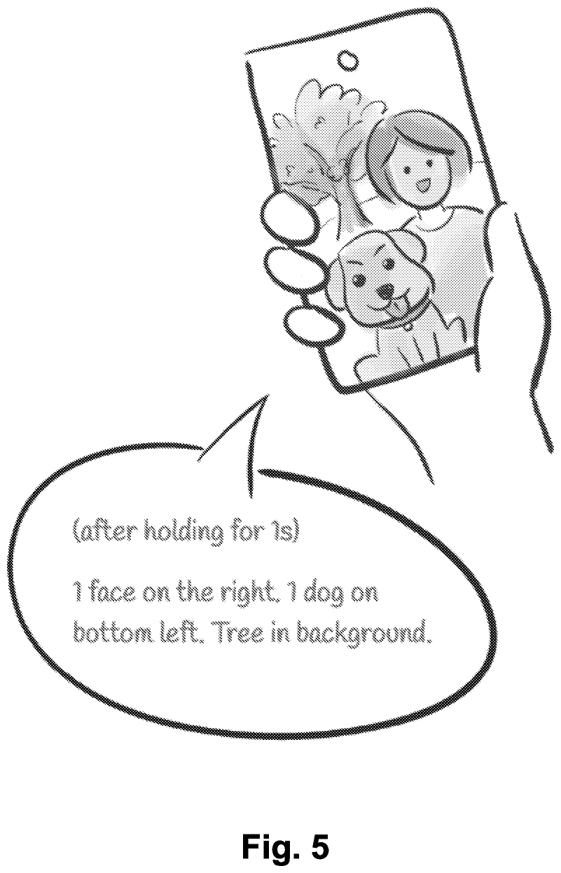

In another aspect, illustrated in FIG. 5, a user may receive an audio detail description in the form of vocal feedback describing what is in the viewfinder to confirm desired faces and objects are included. The image capture application may perform auditory assistance via a speaker to announce to a user what is in the camera frame. For example, assume that a user initiates a front-facing camera of a smartphone to take a selfie. The image capture application is initiated, and the detection controller may detect a face and one or more objects in the viewing area and the image capture application may initiate a smartphone speaker to announce faces and objects in the foreground and/or background. The audio detail description provides confirmation of the content present in the viewfinder for the user. The audio detail description would be helpful to a user who is low-vision or who is otherwise unable to clearly see the viewfinder of the camera on the display. The audio detail description may be provided in addition to the audio, haptic, and/or visual feedback discussed above and illustrated in FIGS. 2 and 3.

In the example audio detail description of the content present in a viewing frame of a smartphone camera illustrated in FIG. 5, the image capture application utilizes a timer to determine the user's intent to take a selfie. For example, when the user holds a viewing frame for a period of time (e.g., 1 second), the image capture application initiates a smartphone speaker to announce faces and objects in the foreground and/or background (e.g., announcing “1 face on the right. 1 dog on the bottom left. Tree in background.”). Responsive to the announcement, the user could reposition the camera to change the objects in frame (e.g., to include a second face).

In another aspect, a user may receive an audio detail description that guides the user to position at least one of the computing device or the user so that the user or another object becomes positioned in frame. For example, assume that a user initiates a front-facing camera of a smartphone to take a selfie. The image capture application is initiated, and the detection controller detects a face in the viewing area. The image capture application may initiate a smartphone speaker to provide instruction to a user to reposition. Such an audio detail description would be helpful to a user who is low-vision or who is otherwise unable to clearly see the viewfinder of the camera on the display. The audio detail description may be provided in addition to the audio, haptic, and/or visual feedback discussed above and illustrated in FIGS. 2 and 3.

For example, the audio detail description may guide the user to position at least one of the computing device or the user so that the user becomes positioned in the frame of the camera. For example, with an announcement of “Move your phone slightly left and down.” After detecting the repositioning by the user, additional announcements may be provided, if necessary. For example, “Move your phone slightly right and up.” Upon detecting a proper position, a confirmatory announcement may be provided (e.g., “Ready for selfie”), along with a countdown (e.g., “three, two, one”). After the image is captured, a further confirmatory announcement may be provided (e.g., “Photo taken. One face.”).

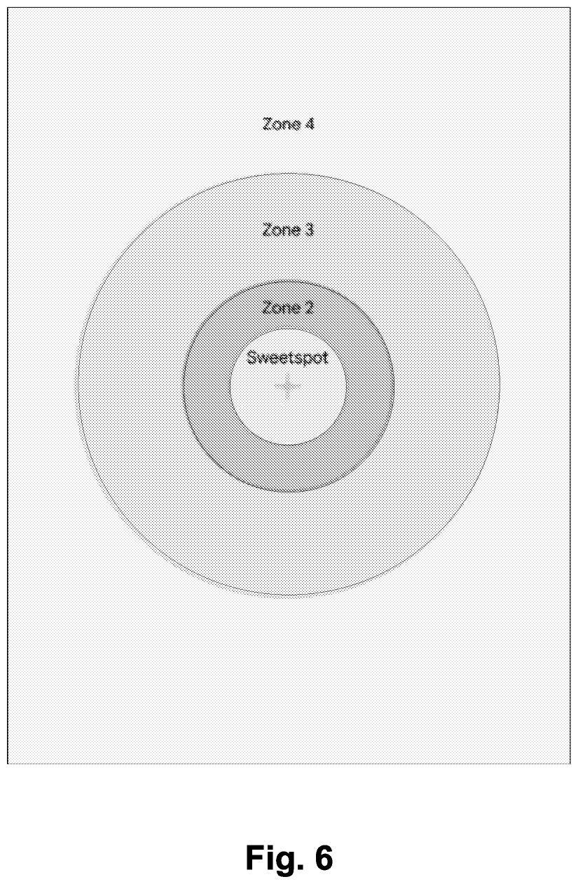

FIG. 6 illustrates zones of a viewfinder of a camera. As illustrated, the viewfinder may include a number of zones in the form of expanding circles surrounding a center of the viewfinder (referred to in the image as the sweet spot). As the face of the user or another object of interest moves between zones (as a result of moving the camera and/or the object), audio, haptic, and/or visual feedback may be provided to indicate to the user that the object is successfully being moved to the center of the viewfinder. The feedback may be dynamically adjusted in real time. In some examples, the outer zone (e.g., Zone 4 in FIG. 6) may correspond to a situation where the face of the user or other object of interest is partially cropped at a border of the viewfinder. One or more additional zones (e.g., Zone 3 and Zone 4 in FIG. 6) may correspond to areas between the border of the viewfinder and the center of the image. An additional zone (e.g., the sweet spot in FIG. 6) may encompass the center of the image.

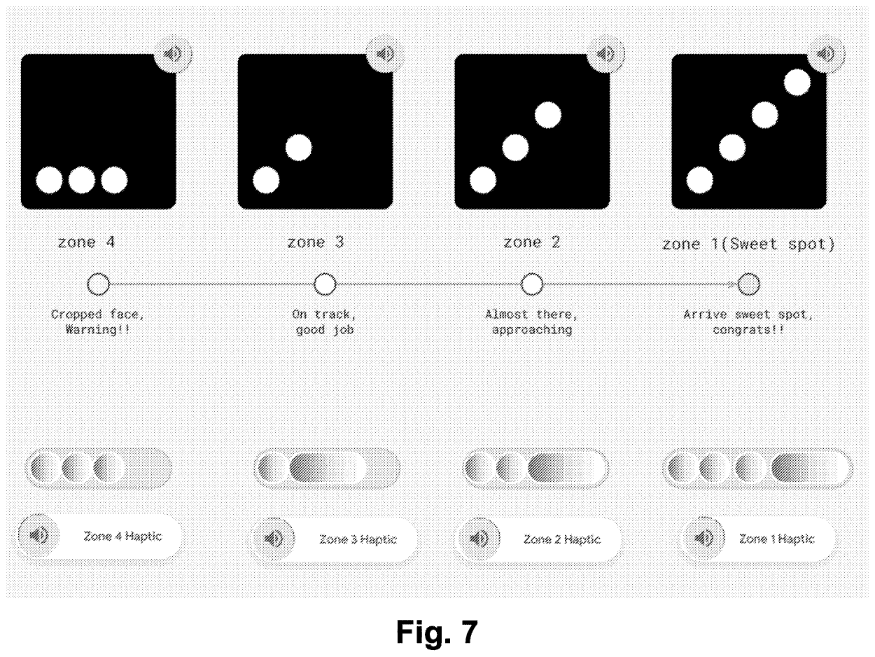

FIG. 7 illustrates feedback associated with different zones of a viewfinder of a camera. More specifically, different types of feedback may correspond to situations where the face of the user or a different object of interest is located in and/or transitioning between different zones of the viewfinder, such as illustrated in FIG. 6. Audio and haptic feedback may be designed to provide a sentimental and distinct feeling for each zone. As the user approaches the sweet spot, the audio feedback may follow a diatonic progression towards resolution. More specifically, as illustrated in FIG. 7, the audio tone may be adjusted as the face of the user or a different object of interest crosses into each zone of the viewfinder illustrated in FIG. 6. Moreover a different haptic pattern for each zone may be auto-generated to match with the audio.

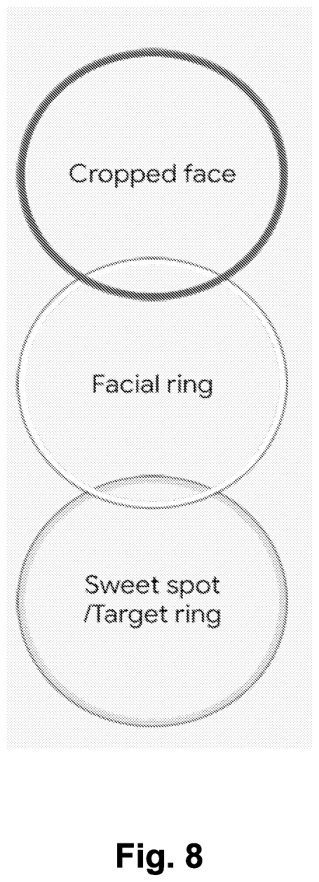

FIG. 8 illustrates different colored rings of a user interface. The rings or a different shape (e.g., square, oval, or rectangle) may be represented surrounding the face of a user or a different object of interest in the viewfinder. Different colors may be used to represent different positioning states of the face or object. For instance, a first color may be used to indicate if the face is cropped, a second color may be used to indicate if the face is fully present within the viewfinder, and a third color may be used to indicate if the face has successfully been positioned at the center of the viewfinder. High contrast colors (e.g., red, white and yellow) may be used to facilitate comprehension and navigation by low-vision users. Moreover, a double contrast ring may be used to highlight the position of the face, and make sure it is visible in different environments.

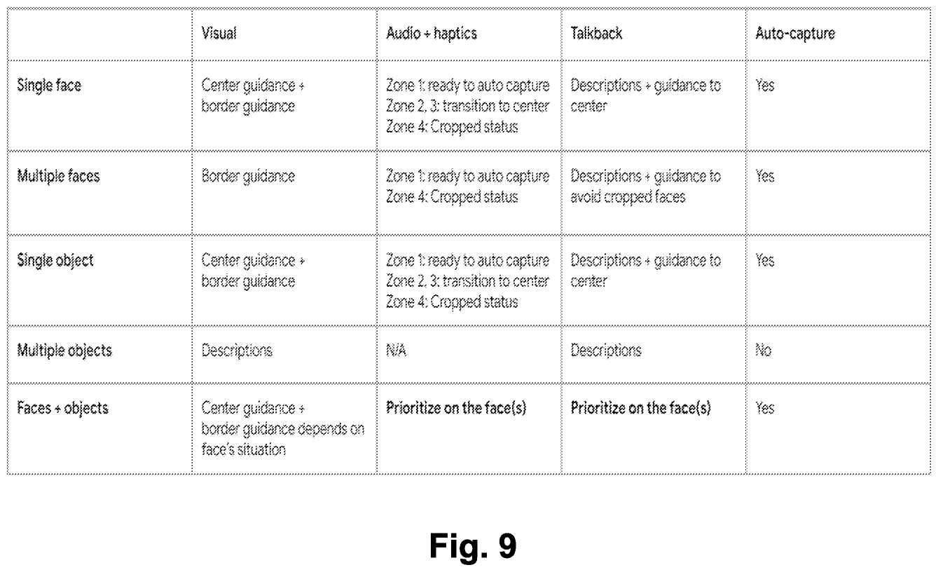

FIG. 9 illustrates a table of object prioritizations. More specifically, depending on the number and type of objects of interest present in an image, different types of audio, visual, and/or haptic feedback may be provided. FIG. 9 is illustrative as different combinations of feedback may be provided for different combinations of objects of interest in other examples.

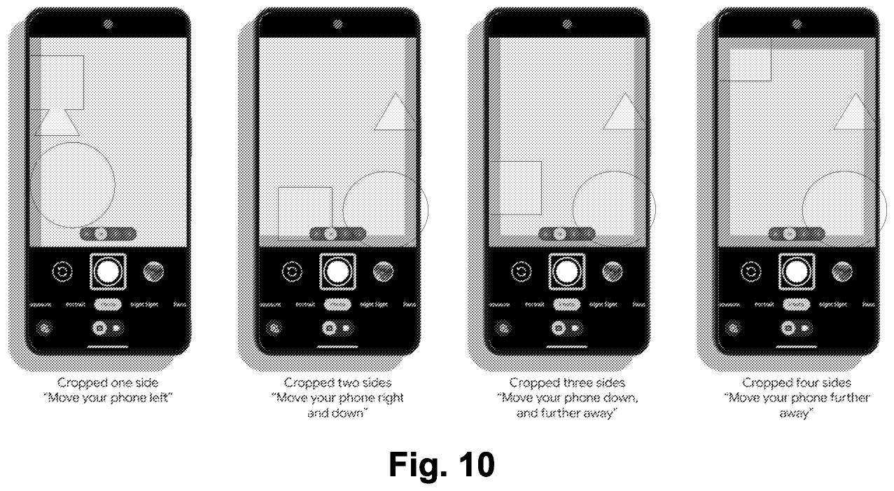

As illustrated in FIG. 9, when only a single face is present in the viewfinder, both center guidance (as previously described) and border guidance (as described in reference to FIG. 10 below) may be provided. Moreover, audio and haptic feedback may follow a pattern based on zones of the viewfinder, such as illustrated and described with reference to FIGS. 6 and 7. Vocal feedback may be provided to identify that a face is located in the viewfinder and to provide guidance to guide the user to move the face to the center of the viewfinder. Auto-capture may be used to automatically capture an image when the face reaches the center of the viewfinder.

In a further example, when multiple faces are present in the viewfinder, only border guidance may be provided. Furthermore, the viewfinder may be divided into different zones based on the number and type of objects present. In this example, only zones indicating whether any faces are cropped or whether all faces are fully present in the viewfinder may be used. Vocal feedback may be provided to identify the number of faces present in the viewfinder and to provide guidance to guide the user to ensure that all of the faces are fully present in the viewfinder. Auto-capture may be used to automatically capture an image when all of the faces are fully present in the viewfinder.

In an additional example, when only a single object of interest (other than a face) is present in the viewfinder, guidance may be provided similar to the single face example. However, when multiple objects are present in the viewfinder, only descriptions may be provided. Moreover, when both one or more faces and one or more objects of interest are present, the faces may be prioritized and guidance may be provided according to the number and positioning of the one or more faces as previously described.

In this manner, the haptic, audio, or visual feedback may be adjusted for a lower priority object depending on whether the image includes a higher priority object. In some examples, the one or more objects of interest are identified from a predefined allowed list of objects. The predefined list may include different priorities for different objects. As an illustrative example, faces may be prioritized over pets which may be prioritized over documents. Other types of objects and object rankings may be used in further examples.

Depending on the types of objects of interest present in the environment, different types of audio description may be provided with different amounts of detail. Examples of such audio description include facial expression, actions, poses, colors, familiarity, body language, relationship with background, position of objects (e.g., depth), and other descriptions of a scene more generally.

FIG. 10 illustrates examples of border guidance. More specifically, when one or more faces and/or other objects of interest are cropped by one or more borders of the viewfinder, the borders may be highlighted (e.g., in an easily visible color) to indicate to a user how to reposition a camera to avoid cropping. Border guidance may therefore involve highlighting one or more borders of the viewfinder which are cropping one or more objects of interest. As illustrated in FIG. 10, multiple borders may be highlighted simultaneously if cropping is occurring at multiple borders simultaneously. Moreover, audio feedback may be provided in parallel to indicate a direction or multiple directions in which to move the camera to avoid cropping and to ensure objects of interest are fully present within the viewfinder.

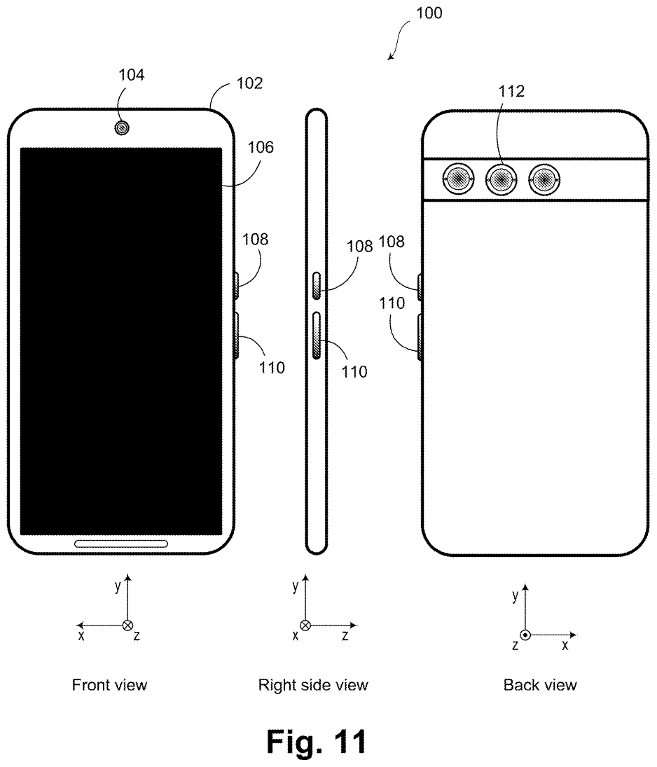

FIG. 11 illustrates an example computing device 100. In examples described herein, computing device 100 may be an image capturing device and/or a video capturing device. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

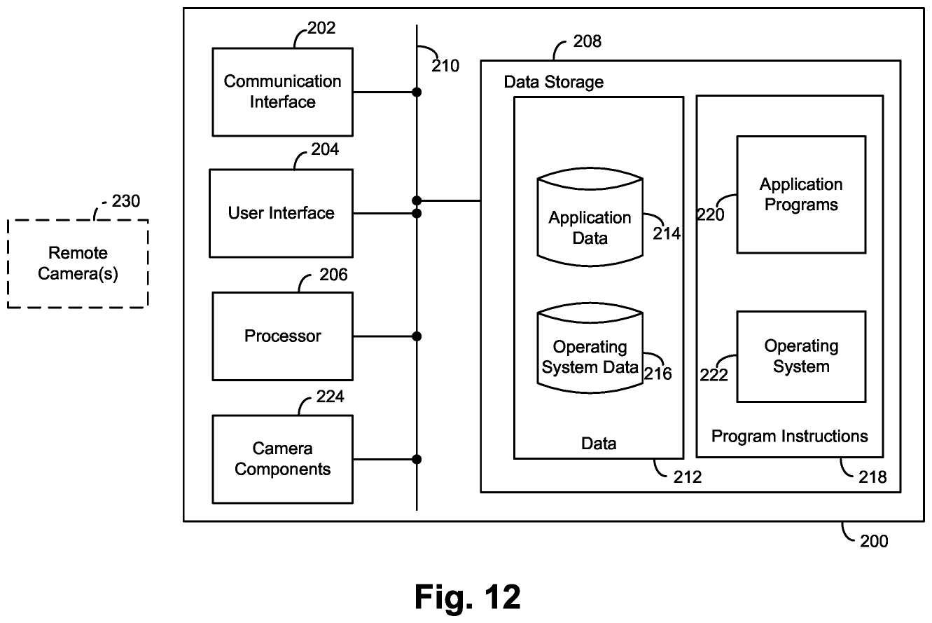

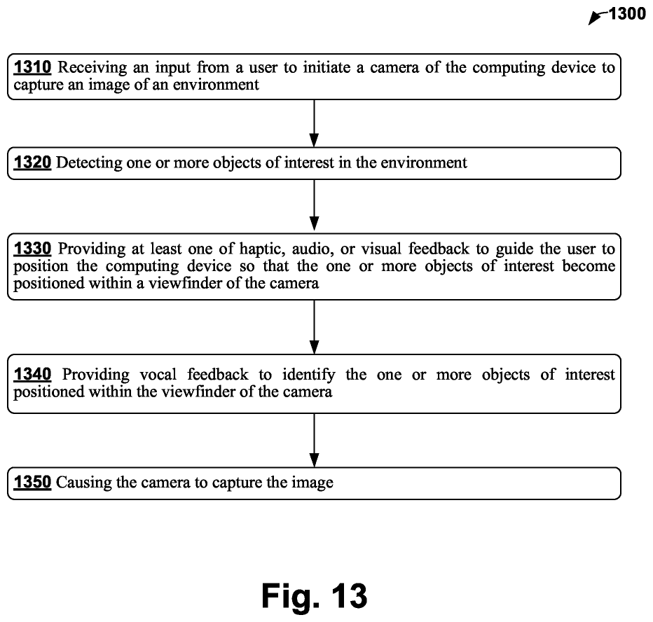

FIG. 12 is a simplified block diagram showing some of the components of an example computing system 200, such as an image capturing device and/or a video capturing device. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 12, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a touch-sensitive panel.

Processor 206 may comprise one or more general purpose processors—e.g., microprocessors—and/or one or more special purpose processors—e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

Histogram processing algorithm(s) 226 may include one or more stored algorithms programmed to process histogram information to facilitate autofocus as described herein. In some examples, histogram processing algorithm(s) 226 may include one or more trained machine learning models. In other examples, histogram processing algorithm(s) 226 may be based on heuristics without the use of machine learning. In further examples, a combination of different types of histogram processing algorithm(s) 226 may be used as well.

In further examples, one or more remote cameras 230 may be controlled by computing system 200. For instance, computing system 200 may transmit control signals to the one or more remote cameras 230 through a wireless or wired connection. Such signals may be transmitted as part of an ambient computing environment. In such examples, inputs received at the computing system 200 (for instance, physical movements of a wearable device) may be mapped to movements or other functions of the one or more remote cameras 230. Images captured by the one or more remote cameras 230 may be transmitted to the computing system 200 for further processing. Such images may be treated as images captured by cameras physically located on the computing system 200.

FIG. 13 is a block diagram of an example method 1300. Method 1300 may be executed by one or more computing systems (e.g., computing system 200 of FIG. 12) and/or one or more processors (e.g., processor 206 of FIG. 12). Method 1300 may be carried out on a computing system, such as computing system 100 of FIG. 11.

At block 1310, method 1300 may involve receiving an input from a user to initiate a camera of the computing device to capture an image of an environment. Such input may involve activating a viewfinder to preview an image that may be captured by a front-facing or rear-facing camera associated with a computing device.

At block 1320, method 1300 may involve detecting one or more objects of interest in the environment. In some examples, the one or more objects of interest may be faces. In further examples, different types of objects of interest may be detected (e.g., pets, documents). In some examples, objects of interest may be identified from a predefined list. One or more object recognition algorithms (e.g., machine learned algorithms) may be used to identify types of objects for purposes of detecting objects of interest in the environment.

At block 1330, method 1300 may involve providing at least one of haptic, audio, or visual feedback to guide the user to position the computing device so that the one or more objects of interest become positioned within a viewfinder of the camera. The feedback may take the form of center guidance and/or border guidance as previously described.

At block 1340, method 1300 may involve providing vocal feedback to identify the one or more objects of interest positioned within the viewfinder of the camera. More specifically, types of objects identified (e.g., a face, a pet) may be announced to inform a user of content present within the image. In some examples, additional vocal feedback may provide further guidance to direct a user in positioning a camera.

At block 1350, method 1300 may involve causing the camera to capture the image. The image may be automatically captured in some circumstances (e.g., when an object of interest has reached the center of the image or when one or more objects of interest are fully contained in the field of view and not cropped). In other examples, image capture may be responsive to a user input.

In some examples of method 1300, the one or more objects of interest may comprise a face of the user, and the haptic, audio, and/or visual feedback may be provided to guide the user to center the face of the user in the image. Such examples may involve determining a distance between a face portion of the image and a center of the image, where the haptic, audio, and/or visual feedback is adjusted dynamically based on the distance. Such examples may further involve dividing the viewfinder into a plurality of zones, where the haptic, audio, and/or visual feedback is adjusted responsive to transitions between respective zones of the plurality of zones. In some examples, the plurality of zones may comprise at least (i) a first zone corresponding to the face of the user partially cropped at a border of the viewfinder, (ii) a second zone between the border of the viewfinder and the center of the image, and (iii) a third zone that encompasses the center of the image. In some examples, the plurality of zones correspond to expanding circles around the center of the image.

In some examples of method 1300, at least one of an intensity or a duration of the haptic feedback is adjusted as the face approaches the center of the image. In some examples, the audio feedback comprises an indication of a direction to move the camera to position the face in the center of the image. In some examples, the visual feedback comprises portions of a circle illuminated to indicate a direction to move the camera to position the face in the center of the image. In some examples, the visual feedback comprises a high-contrast outline surrounding the user or the face of the user. In such examples, brightness of the high-contrast outline increases as the face approaches the center of the image. In some examples, capturing of the image is performed automatically when the face reaches the center of the image.

In some examples of method 1300, providing the vocal feedback to identify the one or more objects of interest positioned within the viewfinder of the camera is performed after the one or more objects of interest are positioned within the viewfinder of the camera for a threshold period of time. In some examples, capturing the image is performed after the one or more objects of interest are positioned within the viewfinder of the camera for a threshold period of time. In some examples, the one or more objects of interest are identified from a predefined allowed list of objects. In some examples, the predefined allowed list of objects comprises corresponding priorities, such that the haptic, audio, and/or visual feedback is adjusted for a lower priority object depending on whether the image includes a higher priority object.

In some examples of method 1300, the visual feedback comprises a shape surrounding an object of interest that changes color depending on whether the object (i) is partially cropped at a border of the viewfinder, (ii) is fully contained within the viewfinder but not at a center of the image, or (iii) is located at the center of the image. In some examples, the visual feedback comprises border guidance highlighting one or more borders of the viewfinder which are cropping one or more objects of interest.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, c-c-c, or any other ordering of a, b, and c).

Although implementations of systems and techniques related to providing real-time feedback to improve self-portrait photographs for camera users have been described in language specific to features and/or methods, it is to be understood that the subject of the appended claims is not necessarily limited to the specific features or methods described. Rather, the specific features and methods are disclosed as example implementations of devices and systems related to providing real-time feedback to improve image capture for camera users.

What is claimed is:

1. A method implemented on a computing device, the method comprising:
receiving an input from a user to initiate a camera of the computing device to capture an image of an environment;
detecting one or more objects of interest in the environment;
providing at least one of haptic, audio, or visual feedback to guide the user to position the computing device so that the one or more objects of interest become positioned within a viewfinder of the camera;
providing vocal feedback to identify the one or more objects of interest positioned within the viewfinder of the camera; and
causing the camera to capture the image.

2. The method of claim 1, wherein the one or more objects of interest comprise a face of the user, and wherein the at least one of the haptic, audio, or visual feedback is provided to guide the user to center the face of the user in the image.

3. The method of claim 2, further comprising:
determining a distance between a face portion of the image and a center of the image, wherein the at least one of the haptic, audio, or visual feedback is adjusted dynamically based on the distance.

4. The method of claim 2, further comprising dividing the viewfinder into a plurality of zones, wherein the at least one of the haptic, audio, or visual feedback is adjusted responsive to transitions between respective zones of the plurality of zones.

5. The method of claim 4, wherein the plurality of zones comprise at least (i) a first zone corresponding to the face of the user partially cropped at a border of the viewfinder, (ii) a second zone between the border of the viewfinder and the center of the image, and (iii) a third zone that encompasses the center of the image.

6. The method of claim 4, wherein the plurality of zones correspond to expanding circles around the center of the image.

7. The method of claim 2, wherein at least one of an intensity or a duration of the haptic feedback is adjusted as the face approaches the center of the image.

8. The method of claim 2, wherein the audio feedback comprises an indication of a direction to move the camera to position the face in the center of the image.

9. The method of claim 2, wherein the visual feedback comprises portions of a circle illuminated to indicate a direction to move the camera to position the face in the center of the image.

10. The method of claim 2, wherein the visual feedback comprises a high-contrast outline surrounding the user or the face of the user.

11. The method of claim 10, wherein brightness of the high-contrast outline increases as the face approaches the center of the image.

12. The method of claim 2, wherein capturing of the image is performed automatically when the face reaches the center of the image.

13. The method of claim 1, wherein providing the vocal feedback to identify the one or more objects of interest positioned within the viewfinder of the camera is performed after the one or more objects of interest are positioned within the viewfinder of the camera for a threshold period of time.

14. The method of claim 1, wherein capturing the image is performed after the one or more objects of interest are positioned within the viewfinder of the camera for a threshold period of time.

15. The method of claim 1, wherein the one or more objects of interest are identified from a predefined allowed list of objects.

16. The method of claim 15, wherein the predefined allowed list of objects comprises corresponding priorities, such that the at least one of the haptic, audio, or visual feedback is adjusted for a lower priority object depending on whether the image includes a higher priority object.

17. The method of claim 1, wherein the visual feedback comprises a shape surrounding an object of interest that changes color depending on whether the object (i) is partially cropped at a border of the viewfinder, (ii) is fully contained within the viewfinder but not at a center of the image, or (iii) is located at the center of the image.

18. The method of claim 1, wherein the visual feedback comprises border guidance highlighting one or more borders of the viewfinder which are cropping one or more objects of interest.

19. A computing device configured to:
receive an input from a user to initiate a camera to capture an image of an environment;
detect one or more objects of interest in the environment;
provide at least one of haptic, audio, or visual feedback to guide the user to position the computing device so that the one or more objects of interest become positioned within a viewfinder of the camera;
provide vocal feedback to identify the one or more objects of interest positioned within the viewfinder of the camera; and
cause the camera to capture the image.

20. A non-transitory computer readable medium comprising program instructions executable by one or more processors to perform operations comprising:
receiving an input from a user to initiate a camera of a computing device to capture an image of an environment;
detecting one or more objects of interest in the environment;
providing at least one of haptic, audio, or visual feedback to guide the user to position the computing device so that the one or more objects of interest become positioned within a viewfinder of the camera;
providing vocal feedback to identify the one or more objects of interest positioned within the viewfinder of the camera; and
causing the camera to capture the image.
